(19) United States
(12) Patent Application Publication
(10) Pub. No.: US 2023/0095085 A1
(43) Pub. Date: Mar. 30, 2023

(54) DRONE TAKEOVER AND REDIRECTING SYSTEM AND METHOD EMPLOYING LANDING OF DRONES

(71) Applicant: OU812 INCORPORATED, Falls Church, VA (US)

(72) Inventor: JAN WILLEM OLGER VALENTIJN KERSEBOOM, Amstelveen (NL)

(21) Appl. No.: 17/909,386

(22) PCT Filed: Mar. 4, 2021
(86) PCT No.: PCT/US21/20861

§ 371 Date: Sep. 4, 2022

Related U.S. Application Data
(60) Provisional application No. 62/984,976, filed on Mar. 4, 2020.

(51) Int. Cl. G08G 5/00; B64U 70/40; B64C 39/02; B64D 1/04; B64D 7/02; H04W 12/122; H04W 12/63

(52) U.S. Cl. CPC G08G 5/0069; G08G 5/0026; G08G 5/0013; G08G 5/0082; B64U 70/40; B64C 39/024; B64D 1/04; B64D 7/02; H04W 12/122; H04W 12/63; B64U 2101/18

(57) ABSTRACT

A system, method and computer program product for controlled drone descent, and deactivation, including a drone deactivation system; and a location system. The drone deactivation system calculates positioning, signal reception, signal strength, and signal identification parameters of a target drone from the location system, and determines an attack method based on the calculated parameters. The drone deactivation system employs the determined attack method against the target drone for forcing at least one of controlled drone descent, and deactivation of the target drone.

### CROSS REFERENCE TO RELATED DOCUMENTS

The present invention is claims priority to U.S. Provisional Patent Application Ser. No. 62/984,976 of KERSEBOOM, entitled “DRONE TAKEOVER AND REDIRECTING SYSTEM AND METHOD EMPLOYING LANDING OF DRONES,” filed on 4 Mar. 2020, now pending, the entire disclosure of which is hereby incorporated by reference herein.

### BACKGROUND OF THE INVENTION

### Field of the Invention

The present invention generally relates to systems and methods for drone hijacking and jamming, and more particularly to systems and methods for taking control over and forcing down drones, including influencing drone parameters, and the like.

### Discussion of the Background

In recent years, drone hacking systems have emerged. However, such systems and methods lack efficient employment of hack parameters, signal strength measurement and geolocation awareness, and the like.

### SUMMARY OF THE INVENTION

Therefore, there is a need for methods and systems that address the above, and other problems. The above and other problems are addressed by the illustrative embodiments of the present invention, which provide systems and methods for employment of controlled drone descent and deactivation, including adjusting geolocation parameters, signal jamming, signal blocking, and the like.

Accordingly, in illustrative aspects of the present invention there is provided a system, method and computer program product for controlled drone descent, and deactivation, including a drone deactivation system; and a location system. The drone deactivation system calculates positioning, signal reception, signal strength, and signal identification parameters of a target drone from the location system, and determines an attack method based on the calculated parameters. The drone deactivation system employs the determined attack method against the target drone for forcing at least one of controlled drone descent, and deactivation of the target drone.

The drone deactivation system includes at least one of a PC, a smart phone, a laptop client, and a server.

The location system includes at least one of a global positioning system, cell tower triangulation system, a Galileo location system, a Glonass location system, and Google location services.

The drone deactivation system includes deactivation resources including countermeasures including at least one of a GPS repositioning system, drone triangulation device, GPS jamming device, drone signal or system intrusion software devices, drone signal or system intrusion hardware devices, a drone position recognition and identifier system, and physical countermeasures, including delivering at least one of electromagnetic pulses, explosives, destructive objects and bullets.

The physical countermeasures include an attack drone delivering at least one of electromagnetic pulses, explosives, destructive objects and bullets.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is a diagram for illustrating systems and methods for employment of controlled drone descent and deactivation; and

FIG. 2 is a detailed diagram for illustrating interaction of drone take over and descent system of FIG. 1;

FIG. 3 is a flowchart for describing the systems and methods for employment of drone descent and deactivation system of FIGS. 1-2; and

FIGS. 4-7 are diagrams for illustrating various housings for controlled drone descent and deactivation system of FIGS. 1-3.

### DETAILED DESCRIPTION OF THE PREFERRED EMBODIMENTS

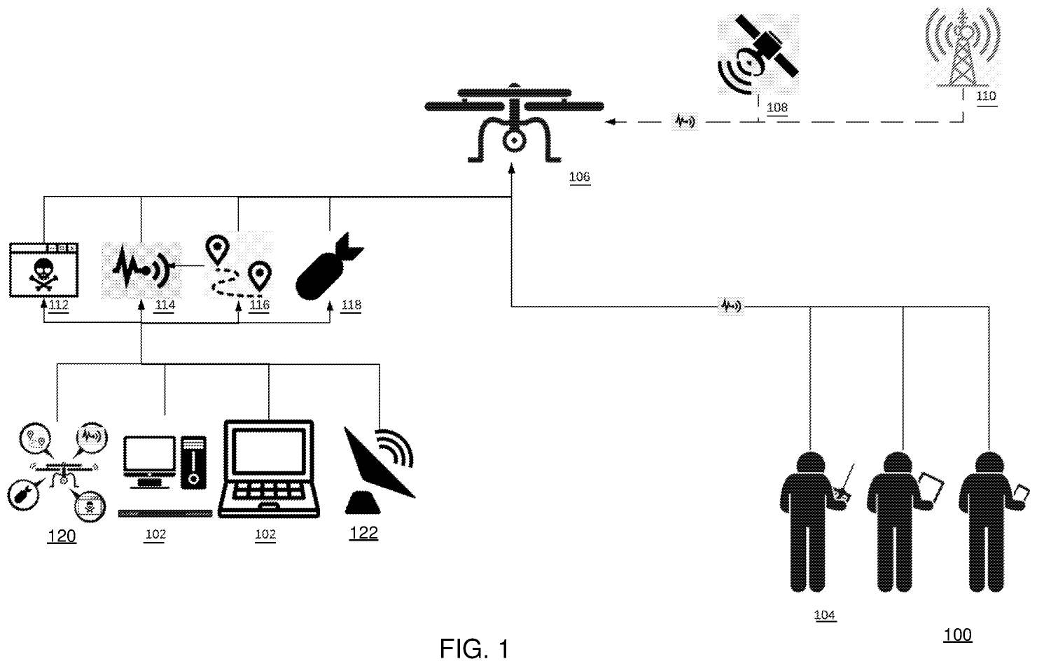

Referring now to the drawings, wherein like reference numerals designate identical or corresponding parts throughout the several views, and more particularly to FIGS. 1-3 thereof, there are shown diagrams for illustrating systems and methods for employment of drone descent and deactivation, including adjusting geolocation parameters, signal jamming, signal blocking, and the like. In FIG. 1, the system 100 can include PCs, smart phones, laptop clients, servers, and the like, 102, location systems 108 and 110 (e.g., global positioning systems, cell tower triangulation, Galileo systems, Glonass systems, Google location services, etc.), a drone deactivation system 122, and drone operator 104 and a target drone 106. Drone descent and deactivation resources 112, 114, 116 and 118 are employed (e.g., countermeasures such as GPS repositioning systems, drone triangulation measures, GPS jamming, drone signal/system intrusion software methods, drone signal/system intrusion hardware methods, Position recognition system and drone identifier system physical countermeasures like electromagnetic pulses, explosives or objects like bullets, etc.). Physical attack means, such as a hunter drone 120 that can propel an object with the intent to physically disable the target drone 106 or employ countermeasures, such as a self-sacrificing directional explosive charge, electromagnetic pulse, and the like can be employed.

By adjusting geolocation parameters, signal jamming and signal blocking, hacking, and the like, or through physical attack means, such as the hunter drone 120, including countermeasures, such as a self-sacrificing directional explosive charge, electromagnetic pulse, and the like, the target drone 106 can be disabled and/or destroyed.

For example, suitable hacking methods 112, such as a script can be employed to hack the target drone 106 by employing any suitable methods of de-authenticating of communications between the target drone 106 and drone operator 104 (e.g., employing suitable systems and methods, such as similar to mdk3, aircrack, etc.), and the like. Thus, hacking methods 112 include a large array of hacking methods that can be used by programs that either try to hack user interaction with the drone 106 or instructing the drone 106 to do something that deviates from the drone operators' instructions, and the like. Craft information gathered by a radio signal sensor array 114 (e.g., frequency sniffer, traffic sniffer, position sniffer, etc.) is employed to generally disinform the drone 106, disinform a geolocation of the drone 106, disinform a flight level of the drone 106, and the like. By using the sensor array 114 surrounding vectors can be obtained in the form of GPS signals, cell tower information, and the broadcasted signals from both the drone 106 and the drone operator 104, and the like. Such gathered signals can be used to triangulate positions and employed by a drone descent tool in a similar way as to how doppler radar works as the source and observer move towards (or away from) each other. Such positions are used to time other attack methods, such as 112, 116 or 118. For example, the attack method 116 replaces or jams the incoming GPS signal of the drone 106 with a static or a fake position regarding height or location combined with the information gathered from the sensors 114. The attack method 118 can be employed to harm the drone 106 by any suitable physically by means, such as employing an object, projectile, electromagnetic pulse, and the like, to harm the drone 106 itself or hardware of the drone 106 using the information gathered from the sensors 114. The sensor data and calculation coming from the sensors 114 is advantageous for various other attack methods to time and/or aim an attack, and the like.

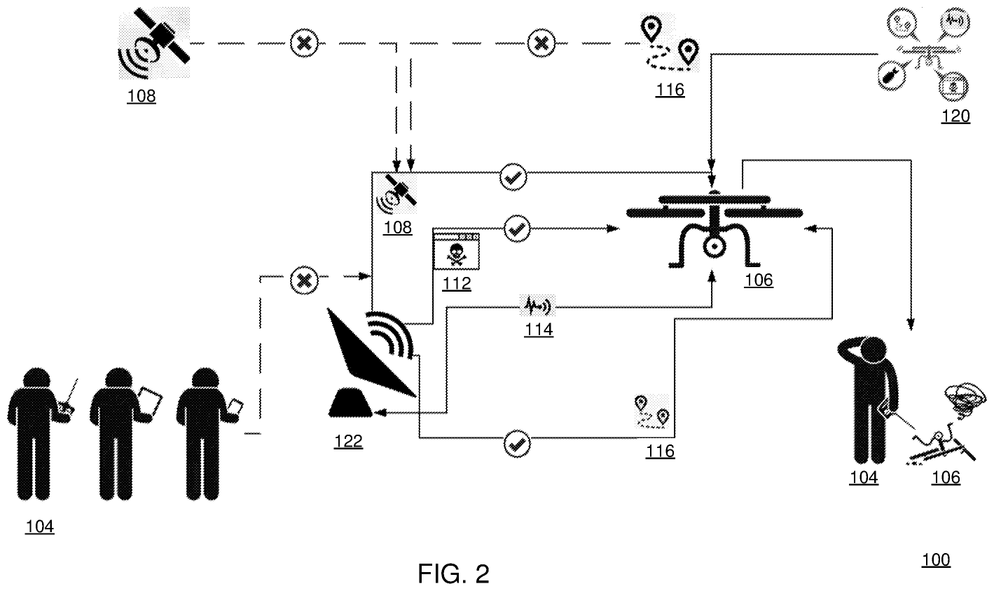

FIG. 2 is a detailed diagram for illustrating drone operator versus the drone descent and deactivation system of FIG. 1. In FIG. 2, the drone operator 104 and the target drone 106 are engaged by the drone descent and deactivation system 122, with interaction that can include drone deactivator tools, such as with the signal sensor system 114 that can collect signal input from location services, from the drone operator 104 signals, from the drone 106 signals, and the like. These captured signals are used to calculate the position of the drone operator 104 and the target drone 106 in order to make a decision on what counter measure to employ, for example, such as generating the positional jamming and/or obfuscating signals 116, employing the hacking methods and systems 112 that can obtain access to and/or instruct the drone, employing the system and method to influence and/or obfuscate location systems 108 and 110), employ the physical attack methods 120, deploy all suitable counter measures as described above (e.g., countermeasures such as GPS repositioning systems/GPS jamming, drone triangulation measures, drone signal/system intrusion software/hardware methods, drone signal/system intrusion hardware methods, position recognition system and drone identifier systems, and the like, towards both the drone operator 104 and the target drone 206. The drone identifier and sensor array 114 and various resource parameters, are employed to determine which countermeasure are used. The system and methods thus can be employed for adjusting geolocation parameters, signal jamming and signal blocking, changing influencing or obfuscating employed signal by hacking, gaining access to the drone 106, and the like. The system and methods can generate preferred parameters for the drone 106 that can deviate from the ones given by the drone operator 104 to disable or attack the drone 106. As previously described, physical attack means, such as the hunter drone 120 can be employed, for example, to propel an object or projectile against the target drone 106 with the intent to physically disable the drone 106 and/or employ countermeasures, such as a self-sacrificing directional explosive charge, electromagnetic pulse, and the like.

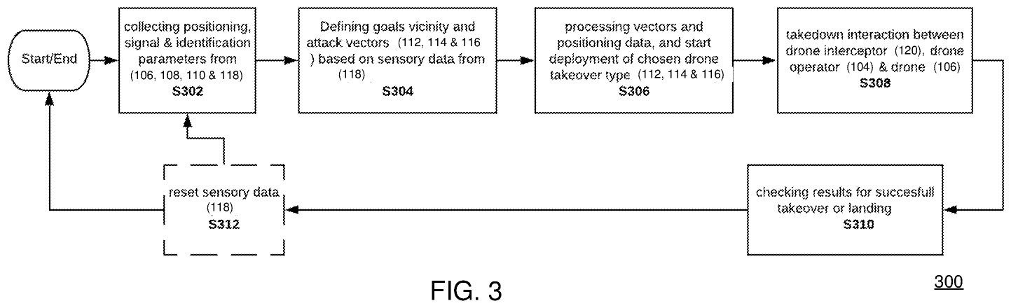

FIG. 3 is a flowchart 300 for describing the systems and methods for employment of drone descent and deactivation system of FIGS. 1-2. In FIG. 3, the flowchart can include, at step S302, collecting positioning, signal and identification parameters from 106, 108, 110 with 118. In steps S304 and S306, the drone capture goals, based on the collected parameters 106, 108, 110 and 118, are defined (e.g., hacking the drone 114, jamming interaction 112 with drone operator 104, obfuscating or influencing drone operating parameters 116, etc.). In step S308, the drone takeover takes place resulting the control of the drone 106 to be gained by the intrusion of the drone takeover system 122, if instructed otherwise to harm the drone 106 physically, withhold command parameters to trigger an auto landing induced by the methods and systems 112 and 116, forced/instructed to land via hacking 114, harming the drone 106 otherwise with attack drone 120 using an EMP, charge or kamikaze like action towards the drone 106, and the like.

For example, at step S304, defined and tactical sensor info, and the like, can be employed to provide adverse or advantageous effects, and the like, on the takedown of the drone 106, such as signal jamming 2112, signal influencing 116, drone-control takeover 114, and the like. Advantageously, this feature can be employed to allow controlled descent of the drone or alter information within the drone. In one example, the drone takeover system can provide misinformation to the drone operator 104 or the drone 106 itself rendering it inoperable or gaining access to the drone 106 itself giving it instructions that deviate from the original ones, and the like.

In step S308, the intrusion of the drone takeover system 122 is executed between the drone operator 104 and the drone 106. At step S310, the drone takeover and/or information blocking/obfuscation and/or instruction replacement and execution, and the like, as previously described, is performed. At step S312, parameters used by the step S302 are updated to a current state based on the parameters of 106, 108, 110 and 118 collected at step S310, completing the process.

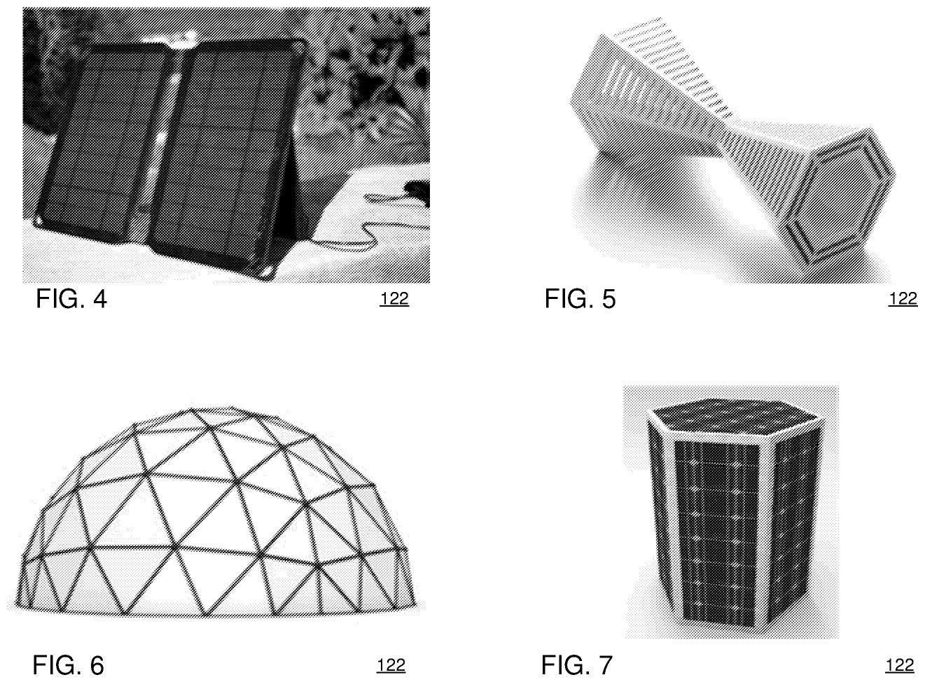

FIGS. 4-7 are diagrams for illustrating various housings for controlled drone descent and deactivation system of FIGS. 1-3. In FIG. 4, is shown, for example, the drone deactivation system 122 configured in a solar powered portable version, and the like. The solar powered drone deactivation system 122 in this configuration is advantageous for outside environments, outside the safety of one's home and/or for any suitable mobile environment, and the like, where portability is advantageous. The drone deactivation system 122 can include an internal battery, can be equipped with solar power, and/or a power cord, and the like, for a standalone or power dependent versions, as needed.

In FIG. 5, is shown an example of drone deactivation system 122 advantageously shaped so as to ideally catch as much radio traffic as possible given a small size to reception ratio, and the like. The radio optimized drone deactivation system 122 in this configuration, due to the angular double helix form, advantageously, ensures that any suitable radio signal bounce is accessible with regard to a desired radio spectrum, and the like. The drone deactivation system 122 can include an internal battery, can be equipped with solar power, and/or a power cord, and the like, for a standalone or power dependent versions, as needed.

In FIG. 6, drone deactivation system 122 can be of a dome type shape, and the like, advantageously, providing relatively broad reception of radio traffic, and the like, as every angle in the 180 degree dome can be picked up by one of the segments thereof. Advantageously, the angles of reception can easily be measured, as each segment is directionally pointed across the sky firmament, and the position of the target drone 106 can therefore be extrapolated, for example, by determining which segment(s) reports the strongest signal, and the like. The drone deactivation system 122 can include an internal battery, can be equipped with solar power, and/or a power cord, and the like, for a standalone or power dependent versions, as needed.

In FIG. 7, the drone deactivation system 122 can be configured to be a standalone, and the like, and so as to withstand the elements, and the like. The ruggedized drone deactivation system 122 can be used as a module that can function unilaterally powered merely with sunlight, and the like. The shape allows for at least 3 segments to always be in the sun, and which are big enough also to power the system at night. The ruggedized drone deactivation system 122 is mobile, can be used at remote and other locations lacking available power, provides redundancy, as needed, and for security reasons assures performance when power outages, and the like, occur. The ruggedized drone deactivation system 122 is particularly advantageous for use on boats, road vehicles, mobile platforms, and the like, that do not directly facilitate power outlets, and the like. The drone deactivation system 122 can include an internal battery, can be equipped with solar power, and/or a power cord, and the like, for a standalone or power dependent versions, as needed.

In further embodiments, the system and method can include other counter measures as physical destruction methods, such as deliberate collision with another drone or other object, such as a bullet or a high energy pulse, such as an Electro Magnetic Pulse, and the like, controlled by the drone takedown and descent system, based on the teaching of the present disclosure, and as will be appreciated by those of ordinary skill in the relevant art(s).

Advantageously, the illustrative systems and methods, provide employment of drone descent and deactivation system, including adjusting geolocation parameters, signal jamming and signal blocking, physical attack means, such as a hunter drone. including countermeasures, such as a self-sacrificing directional explosive charge, electromagnetic pulse parameters, and the like.

Although the illustrative systems and methods are described in terms of employment of drone descent and deactivation system, including adjusting geolocation parameters, signal jamming and signal blocking or physical attack means, such as a hunter drone, including countermeasures, such as a self-sacrificing directional explosive charge or electromagnetic pulse parameters, and the like, the illustrative systems and methods can be applied to any other suitable types of operator vs client takedown applications, and the like, based on the teaching of the present disclosure, and as will be appreciated by those of ordinary skill in the relevant art(s).

The above-described devices and subsystems of the illustrative embodiments can include, for example, any suitable servers, workstations, PCs, laptop computers, PDAs, Internet appliances, handheld devices, cellular telephones, wireless devices, other devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, G3 communications networks, Public Switched Telephone Network (PSTNs), Packet Data Networks (PDNs), the Internet, intranets, a combination thereof, and the like.

It is to be understood that the devices and subsystems of the illustrative embodiments are for illustrative purposes, as many variations of the specific hardware used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance of the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present inventions. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, and the like, programmed according to the teachings of the illustrative embodiments of the present inventions, as will be appreciated by those skilled in the computer and software arts. Appropriate software can be readily prepared by programmers of ordinary skill based on the teachings of the illustrative embodiments, as will be appreciated by those skilled in the software art. Further, the devices and subsystems of the illustrative embodiments can be implemented on the World Wide Web. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present inventions can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present inventions for performing all or a portion (if processing is distributed) of the processing performed in implementing the inventions. Computer code devices of the illustrative embodiments of the present inventions can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present inventions can be distributed for better performance, reliability, cost, and the like.

As stated above, the devices and subsystems of the illustrative embodiments can include computer readable medium or memories for holding instructions programmed according to the teachings of the present inventions and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

Accordingly, the computer implemented system, method and computer program product for employing drone descent and deactivation system, includes adjusting geolocation parameters, signal jamming and signal blocking or physical attack means, such as a hunter drone including countermeasures as a self-sacrificing directional explosive charge or electromagnetic pulse parameters, and the like.

While the present inventions have been described in connection with a number of illustrative embodiments, and implementations, the present inventions are not so limited, but rather cover various modifications, and equivalent arrangements, which fall within the purview of the appended claims.

What is claimed is:

1. A computer implemented system for controlled drone descent, and deactivation, the system comprising:
a drone deactivation system; and
a location system;
wherein the drone deactivation system calculates positioning, signal reception, signal strength, and signal identification parameters of a target drone from the location system, and determines an attack method based on the calculated parameters, and
the drone deactivation system employs the determined attack method against the target drone for forcing at least one of controlled drone descent, and deactivation of the target drone.

2. The system of claim 1, wherein the drone deactivation system includes at least one of a PC, a smart phone, a laptop client, and a server.

3. The system of claim 1, wherein the location system includes at least one of a global positioning system, cell tower triangulation system, a Galileo location system, a Glonass location system, and Google location services.

4. The system of claim 1, wherein the drone deactivation system includes deactivation resources including countermeasures including at least one of a GPS repositioning system, drone triangulation device, GPS jamming device, drone signal or system intrusion software devices, drone signal or system intrusion hardware devices, a drone position recognition and identifier system, and physical countermeasures, including delivering at least one of electromagnetic pulses, explosives, destructive objects and bullets.

5. The system of claim 4, wherein the physical countermeasures include an attack drone delivering at least one of electromagnetic pulses, explosives, destructive objects and bullets.

6. A computer implemented method for controlled drone descent, and deactivation, the method comprising:
calculating with a drone deactivation system positioning, signal reception, signal strength, and signal identification parameters of a target drone from a location system;
determining with the drone deactivation system an attack method based on the calculated parameters; and
employing with the drone deactivation system the determined attack method against the target drone for forcing at least one of controlled drone descent, and deactivation of the target drone.

7. The method of claim 6, wherein the drone deactivation system includes at least one of a PC, a smart phone, a laptop client, and a server.

8. The method of claim 6, wherein the location system includes at least one of a global positioning system, cell tower triangulation system, a Galileo location system, a Glonass location system, and Google location services.

9. The method of claim 6, wherein the drone deactivation system includes deactivation resources including countermeasures including at least one of a GPS repositioning system, drone triangulation device, GPS jamming device, drone signal or system intrusion software devices, drone signal or system intrusion hardware devices, a drone position recognition and identifier system, and physical countermeasures, including delivering at least one of electromagnetic pulses, explosives, destructive objects and bullets.

10. The method of claim 9, wherein the physical countermeasures include an attack drone delivering at least one of electromagnetic pulses, explosives, destructive objects and bullets.

11. A computer program product for controlled drone descent, and deactivation and including one or more computer readable instructions embedded on a tangible, non-transitory computer readable medium and configured to cause one or more computer processors to implement a method comprising:
calculating with a drone deactivation system positioning, signal reception, signal strength, and signal identification parameters of a target drone from a location system;
determining with the drone deactivation system an attack method based on the calculated parameters; and
employing with the drone deactivation system the determined attack method against the target drone for forcing at least one of controlled drone descent, and deactivation of the target drone.

12. The computer program product of claim 11, wherein the drone deactivation system includes at least one of a PC, a smart phone, a laptop client, and a server.

13. The computer program product of claim 11, wherein the location system includes at least one of a global positioning system, cell tower triangulation system, a Galileo location system, a Glonass location system, and Google location services.

14. The computer program product of claim 11, wherein the drone deactivation system includes deactivation resources including countermeasures including at least one of a GPS repositioning system, drone triangulation device, GPS jamming device, drone signal or system intrusion software devices, drone signal or system intrusion hardware devices, a drone position recognition and identifier system, and physical countermeasures, including delivering at least one of electromagnetic pulses, explosives, destructive objects and bullets.

15. The computer program product of claim 14, wherein the physical countermeasures include an attack drone delivering at least one of electromagnetic pulses, explosives, destructive objects and bullets.
